(19) United States
(12) Patent Application Publication
(10) Pub. No.: US 2003/0003204 A1
(43) Pub. Date: Jan. 2, 2003

(54) Cookie making implement and method of using same

(76) Inventor: John F. Cooper, Barrington, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 09/892,261

(22) Filed: Jun. 27, 2001

(51) Int. Cl. A23P 1/00; A23L 1/00

(52) U.S. Cl. 426/383; 99/537

(57) ABSTRACT

A dough cutting and decorating tool that includes a generally flat base with a continuous raised cutting edge defining a shape extending from one side of the base. A raised printing surface extends from the other side of the base, with the printing surface having a pattern configured to fit within the shape defined by the raised cutting edge on the other side of the base. In certain preferred embodiments, the cutting edge coincides with the peripheral edge of the base, while the printing surface is made of a resilient material, such as a compressible cellular foam material.

### BACKGROUND OF THE INVENTION

The present invention relates to a cookie making implement and, more particularly, to a dough cutting and decorating tool and the method for its use.

Cookies have long been a popular desert or snack item. Their generally small size and firm consistency allows enthusiastic eaters to enjoy cookies without resort to utensils such as forks or spoons. This aspect makes cookies particularly popular among children and their families.

Cookies also tend to be relatively easy to make, so that making—and eating—cookies has been a favorite activity for families with children. While artistically decorating cookies may be merely time consuming for adults, it is a difficult task for young children who have not yet acquired the steady hand and artistic vision needed to produce consistently pleasing cookie decorating results.

In addition, decorating options have moved beyond the traditional icings and sprinkles and include what is known as “edible paints.” Edible paints have become increasingly popular for a number of children's activities and typically include a food color mixed with, e.g., powdered milk or egg yolks—while not specifically intended as a food item, edible paints provide additional options for food decorating.

Accordingly, it is an object of the present invention to provide a single cookie making implement that may be used to both shape the unbaked cookie dough and decorate the baked cookie.

More particularly, it is an object of the present invention to provide a combination cookie cutter and decorating tool that is readily useable by children and allows the user to easily and consistently decorate the baked cookie shapes made with the cutter.

It is a further object of the present invention to provide a cookie making implement that facilitates the decoration of the cookie with edible paints.

It is a related object to provide a method for cutting cookie dough and decorating a baked cookie using a single implement.

### SUMMARY OF THE INVENTION

These objects, as well as others which will become apparent upon reference to the following detailed description and accompanying drawings, are provided by a dough cutting and decorating tool that includes a generally flat base with a continuous raised cutting edge defining a shape extending from one side of the base. A raised printing surface extends from the other side of the base, with the printing surface having a pattern configured to fit within the shape defined by the raised cutting edge on the other side of the base. In certain preferred embodiments, the cutting edge coincides with the peripheral edge of the base, while the printing surface is made of a resilient material, such as a compressible cellular foam material.

A method for using the dough cutting and decorating tool for cutting a defined shape from a generally flat and soft dough-like material is also disclosed in which the continuous raised edge of the cutting implement is pressed into the dough-like material to cut a defined shape therefrom. The cut material is then baked and a colorant is applied to the raised printing surface of the cutting implement, which is then placed in face-to-face registration with the baked dough. The raised printing surface is then pressed against the baked dough to transfer the colorant from the raised printing surface to the baked item.

### BRIEF DESCRIPTION OF THE DRAWINGS

FIG. 1 is a top view of a dough cutting and decorating implement incorporating the present invention showing the decorating portion of the implement.

FIG. 2 is a bottom view of a dough cutting and decorating implement incorporating the present invention showing the dough cutting portion of the device.

FIG. 3 is a perspective view of the implement of FIG. 1 showing the decorating portion of the device.

FIG. 4 is a perspective view of the dough cutting and decorating implement of FIG. 1 showing the dough cutting portion of the device.

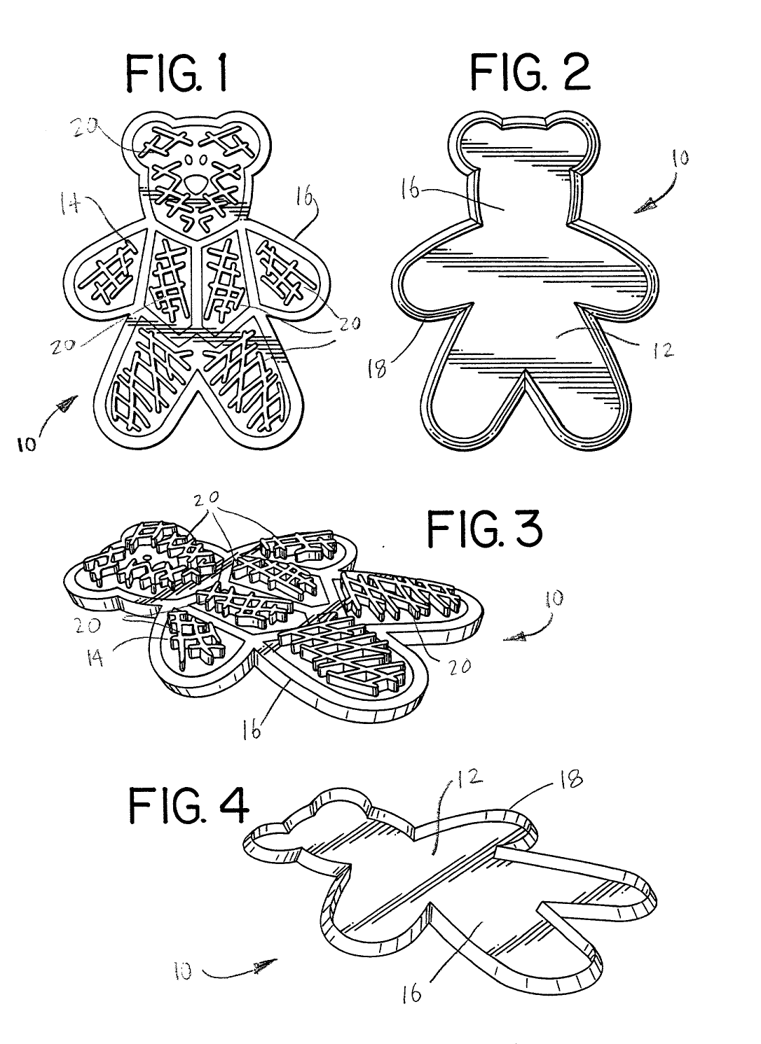

### DETAILED DESCRIPTION OF THE PREFERRED EMBODIMENT

Turning to the figures of the drawings, there is seen a dough cutting and decorating implement 10 in accordance with the present invention. The device includes a dough cutting portion 12 on one face and a decorating portion 14 on the opposite face. The dough cutting portion 12 includes a generally planar base 16 from which a continuous raised cutting edge 18 defining a shape extends. In the illustrated embodiment, the cutting edge coincides with the peripheral edge of the base and defines the outline of a teddy bear. Other shapes, of course, may be used.

The decorating portion 14 of the device 10 includes a raised surface that has a pattern configured to fit within the shape defined by the raised cutting edge. In particular, a plurality of raised printing surfaces 20 are shown that correspond to the arms, legs, and head of the teddy bear, as well as a vest worn by the bear. The raised printing surface is preferably made of a resilient material such as a compressive cellular foam.

In use, the device 10 is used to cut a shape in the figure of the bear from a soft material that is rolled out in advance. The soft material is usually cookie dough, but could include other, non-edible substances. The dough is rolled out in advance and the cookie is cut with the dough cutting side 12 of the device 10 by compressing the continuous raised edge 18 into the dough and removing the excess dough for later use. The dough is baked in the traditional manner, resulting in a hardening or stiffening of the dough in the baked cookie.

The baked cookie is then decorated using the second portion 14 of the device. A colorant, such as a food color or edible paint is applied to the raised printing surface 20, which is then pressed against the baked cookie to transfer the food color or edible paint to the cookie. While the disclosed device creates a cookie that is symmetrical about a center line, non-symmetrical shapes may also be used. It merely requires that the cookie be flipped after baking to have the face-up shape correspond to the shape of the decorating stamp.

The cutter portion of the device may be made of plastic by injection molding or of a stamped sheet metal. The printing surface may be molded directly to the cutter. Preferably it is made separately of a softer material than the cookie cutter portion, which may then be affixed to the cookie cutter portion by a suitable adhesive.

While the invention has been described in terms of a preferred embodiment, there is no intent to limit it to the same. Instead, the invention is defined by the accompanying claims.

What is claimed:

1. A dough cutting and decorating implement comprising:
a generally planar base having first and second sides and a peripheral edge;
a continuous raised cutting edge defining a shape extending from the first side of the base; and
a raised printing surface extending from the second side of the base, the printing surface having a pattern configured to fit within the shape defined by the raised cutting edge on the first side of the pace.

2. The dough cutting and decorating implement of claim 1 wherein the cutting edge coincides with the peripheral edge of the base.

3. The dough cutting and decorating implement of claim 1 wherein the printing surface is made of a resilient material.

4. The dough cutting and decorating implement of claim 1 wherein the printing surface is made of a compressive cellular foam material.

5. The method of cutting a defined shape from a generally planar, relatively soft material and imprinting a design on the cut material comprising:
providing a cutter having a generally planar base having first and second sides and a peripheral edge, a continuous raised cutting edge defining a shape extending from the first side of the base, and a raised printing surface extending from the second side of the base, the printing surface having a pattern configured to fit within the shape defined by the raised cutting edge on the first side of the base;
pressing the continuous raised edge of the cutting implement into the material to cut a defined shape from the material;
baking the cut material;
applying a colorant to the raised printing surface of the cutting implement;
placing the raised printing surface of the cutting implement in face-to-face registration with the cut material; and
pressing the raised printing surface against the cut material to transfer the colorant from the raised printing surface to the cut material.
